(19) United States
(12) Patent Application Publication
(10) Pub. No.: US 2026/0205029 A1
(43) Pub. Date: Jul. 16, 2026

(54) POWER MODULE, ELECTRIC POWER CONVERTER AND ELECTRIC DRIVE FOR A MEAN OF TRANSPORT

(71) Applicant: VALEO EAUTOMOTIVE GERMANY GMBH, Erlangen (DE)

(72) Inventors: Christian HEROLD, Erlangen (DE); Benedikt LUNZ, Erlangen (DE); Alexander BUCHER, Erlangen (DE)

(73) Assignee: VALEO EAUTOMOTIVE GERMANY GMBH, Erlangen (DE)

(21) Appl. No.: 19/137,854

(22) PCT Filed: Dec. 20, 2023
(86) PCT No.: PCT/EP2023/086991

§ 371 Date: Jun. 11, 2025

(30) Foreign Application Priority Data
Dec. 22, 2022 (DE) 10 2022 134 658.7

(51) Int. Cl. H02M 7/537; B60L 53/22; H02M 7/00

(52) U.S. Cl. CPC H02M 7/537; B60L 53/22; H02M 7/003; B60L 2210/40

(57) ABSTRACT

Power module includes a carrier and multiple dies connected to a parallel connection and each forming a transistor with a switching path. Each die has first, second, and control terminals, the switching path formed between first and second terminals and being switchable depending on voltage across control and second terminals. The first terminals are connected to form the parallel connection. A connector connects a signal source to the power module, and an electric conductor connects the connector to a designated terminal of a respective die, which is either the second or control terminal. The electric conductor has a trace section formed on the carrier and an attachment section connecting the trace section with the designated terminal. The carrier and trace section are part of a substrate holding the dies and connector. The trace section and attachment section provide electric resistance at least 1 Ω between the connector and designated terminal.

### FIELD OF THE INVENTION

The present invention relates to a power module comprising: a carrier; multiple dies being connected to a parallel connection and each forming a transistor with a switching path, each die having a first terminal, a second terminal and a control terminal, the switching path being formed between the first terminal and the second terminal and being switchable depending on a voltage across the control terminal and the second terminal, the first terminals of the dies being connected with each other so as to form the parallel connection; a connector configured to connect a signal source to the power module; and an electric conductor being made at least partially of an electrically conductive material and connecting the connector to a designated terminal of a respective one of the dies, the designated terminal being chosen from a group consisting of the second terminal and the control terminal, the electric conductor having a trace section formed on the carrier and an attachment section connecting the trace section with the designated terminal of the respective one of the dies; the carrier and the trace section being part of a substrate, on which the dies and the connector are mounted.

Aside, the invention relates to an electric power converter, to an electric drive for a mean of transport and to a mean of transport comprising an electric drive according to the invention.

A mean of transport is for example a motorized ground vehicle, a train, an aircraft or a drone. A motorized ground vehicle is for example an automotive vehicle, a motorcycle, a motorized bicycle or a motorized wheelchair.

### BACKGROUND OF THE INVENTION

M. Wang, F. Luo and L. Xu, “An optimized gate-loop layout for multi-chip SiC MOSFET power modules,” 2015 IEEE 3^{rd} Workshop on Wide Bandgap Power Devices and Applications (WiPDA), 2015, pp. 215-219, disclose a power module with parallel connected MOSFETs. A Kelvin source structure is adopted in the power module, where thin wire bonds connect gate and source pads of the MOSFETs to traces connected to a gate-loop lead frame.

With the increase of demand of power provided by traction inverters for electric vehicles, paralleling multiple dies has become an appropriate way in order to cope with the corresponding current and loss densities. However, connecting the dies in parallel leads to very complex resonant systems with distinctive feedback loops. Corresponding oscillations can be expected in the VHF band, particularly above 100 MHz, and can trigger different failure mechanisms with a structure of the control terminals of the dies.

The above document by M. Wang, F. Luo and L. Xu proposes to integrate individual discrete gate resistors into the power module by opening the traces between the gate loop lead frame and the wire-bonds to suppress the oscillation between gate loops during switching transients. However, such a solution requires additional discrete components and additional manufacturing steps for placing them on the substrate.

### SUMMARY OF THE INVENTION

It is an object of the present invention to provide an improved possibility to reduce oscillation during operating of a power module with parallelized dies, in particular with less manufactural effort and/or without redesigning the dies.

According to the invention, the above object is solved by a power module as initially described, in which the trace section and the attachment section of the electric conductor provide an electric resistance of at least 1 Ω between the connector and the designated terminal of a respective one of the dies.

The power module according to the invention comprises a carrier and multiple dies. The dies are connected to a parallel connection. The dies each form a transistor. The transistor has a switching path. Each die has a first terminal, a second terminal and a control terminal. The switching path is formed between the first terminal and the second terminal. The switching path is switchable depending on a voltage across the control terminal and the second terminal. The first terminals of the dies are connected with each other so as to form the parallel connection. The power module further comprises a connector configured to connect a signal source to the power module. The power module further comprises an electric conductor. The electric conductor is made at least partially of an electrically conductive material. The electric conductor connects the connector to a designated terminal of a respective one of the dies. The designated terminal is chosen from a group consisting of the second terminal and the control terminal. The electric conductor has and an attachment section. The trace section is formed on the carrier. The attachment section connects the trace section with the designated terminal of the respective one of the dies: The carrier and the trace section are part of a substrate. The dies are mounted on the substrate. The trace section and the attachment section of the electric conductor provide an electric resistance of at least 1 Ω between the connector and the designated terminal of a respective one of the dies.

In conventional power modules, designers seek to implement the trace section and the attachment section such that they provide a relative low resistance, significantly smaller than the resistance proposed by the invention, e.g., by forming them from copper, aluminum, gold or silver and/or with rather large cross-sectional area. In contrast, the invention proposes to implement a relatively high resistance in a respective current path between the connector and the die. This resistance value allows to dampen feedback loops that cause oscillations without adding discrete resistors into the current path. In other words, the invention proposes to design the electric conductor such that the trace section and/or the attachment section provide the desired resistance value themselves. This allows to dampen VHF oscillations in power modules with parallelized dies without the need to add steps of mounting discrete resistors to the general manufacturing process for a corresponding power module and/or to redesign the internal structure of the dies.

The number of dies may be at least two, preferably at least four, more preferably at least six. Preferably, the transistor is configured to block voltages of at least 400 V, preferably at least 800 V, more preferably at least 1200 V, over the switching path. However, the invention may also be used in applications, where the transistor is a configured to block voltages between 20 V and 400 V, or in high-voltage applications, where the voltage is at least 10 kV. Of course, the dies may have further terminals, such as a terminal for sensing an internal voltage and/or a terminal for an internal current mirror.

The transistor may be a metal oxide semiconductor field effect transistor (MOSFET), preferably based on silicon carbide (SiC), or a high-electron-mobility transistor (HEMT), preferably based on gallium nitride. With regard to MOSFETs and HEMTs, the first terminal may be a drain terminal and the control terminal may be a gate terminal. Alternatively, the transistor may be an insulated gate bipolar transistor (IGBT). In this case, the first terminal may be a collector terminal and the control terminal may be a gate terminal.

In detail, electrical connections between the dies may form a resonant circuit with a resonance frequency of at least 100 MHz and feedback loops that form an inductive coupling between the second terminals and the control terminals on the. Then, the value of the resistance is chosen to dampen the inductive coupling below a level, at which switching the transistor damages the die. The resistance value may be even chosen such that the oscillations are suppressed by the resonant circuit being operated in an aperiodic state.

In particular, the resistance between the connector and a respective designated terminal may be at least 2 Ω, preferably at least 4 Ω, more preferably at least 6 Ω or even 10 Ω. Preferably the resistance between the connector and the respective designated terminal may be at most 100 Ω, preferably at most 50 Ω.

In detail, the attachment section may form distinct electrical connections between the trace section and the designated terminal of the respective one of the dies, wherein the resistance is measured between the connector and the designated terminal via the distinct electrical connection formed by the attachment section.

With regard to the power module according to the invention, the trace section may be formed continuously between the connector and the attachment section. I.e., the trace section may form a continuous path over the entire way from the connector to the attachment section. In particular, over its entire way from the connector to the attachment section, the trace section is formed integrally and/or extends upon the carrier.

Further, the attachment section may be attached to the trace section and to pads of the dies forming the designated terminals. Preferably, the attachment section extends between the trace section and the pad by forming a clearance to the carrier. In particular, an end of the attachment section being attached to the trace section has a first distance to the carrier and the other end of the attachment section being attached to the pads has a second distance to the carrier, the second distance being larger than the first distance. In particular, there is no direct contact between the attachment and the carrier over the entire extent of the attachment section. The trace section and the attachment section may in general differ from each other in that the trace section extends upon the carrier, whereas the attachment section is attached to the trace section and the designated terminals and has no direct contact to the carrier. Preferably, the attachment section is formed by wire bonds or flat strips.

In particular, the electrically conductive material has a resistivity of at least 2.0·10⁻⁷ Ωm, preferably at least 3.5·10⁻⁷ Ωm, more preferably at least 4.0·10⁻⁷ Ωm. Such resistivity values may be sufficiently large to achieve the above resistance by making conductor at least partially of the material.

The electrically conductive material may be a copper-manganese-nickel alloy. Preferably, the alloy comprises A wt. % copper, B wt. % manganese and C wt. % nickel with A+B+C≤100, 81≤A≤88, 11≤B≤15 and 1≤C≤4. E.g., Manganin® is such an alloy that is commercially available. Alternatively, the alloy comprises D wt. % copper, E wt. % nickel, F wt% manganese with D+E+F≤100, 53≤D≤57, 42.5≤E≤45 and 0.5≤F≤1.2, wherein when D+E+F<100, the alloy further comprises G wt. % of a further metal, e.g., iron, and D+E+F+G=100. E.g., Konstantan® is such an ally that is commercial available.

Alternatively, the electrically conductive material may be a nickel-chromium alloy. Preferably, the alloy comprises H wt. % nickel, J wt. % chromium, with H+J≤100, 75≤H≤85, 15≤J≤20, wherein, when H+J<100, the alloy further comprises K wt. % of a further metal and H+J+K=100. A commonly known alloy with this composition is, e.g., nichrome.

Alternatively, the electrically conductive material may be an iron-chromium-aluminum alloy with L wt. % chromium, M wt. % aluminum and N wt. % iron, with L+M+N =100, 20≤L≤30 and 4≤M≤7.5. E.g., Kanthal® is such an alloy that is commercially available.

Preferably, the attachment section is made of the electrically conductive material. Alternatively, the attachment section may comprise a core and an outer cladding surrounding the core, the core or the cladding being made of the electrically conductive material. In this case, the core may be made of the electrically conductive material and the cladding is made of aluminum or, in the alternative, the core may be made of an electrically insulating material, particularly a polymer, and the cladding may be made of the or an electrically conductive material.

Preferably, the trace section is made of the electrically conductive material. If the attachment section is made of or comprises the electrically conductive material, the trace section may be made of a second electrically conductive material. Alternatively, If the trace is made of the electrically conductive material, the attachment section, in particular the cladding, may be made of a second electrically conductive material.

Also, the connector may be made of the or a second electrically conductive material. The resistivity of the first electrically conductive material may be at least ten times the resistivity of said second electrically conductive material. The second electrically conductive material may be copper or aluminum.

The carrier may be made of ceramics, therein realizing a direct bonded copper substrate (DBC), a direct bonded aluminum substrate (DBA) or an active metal brazed substrate (AMB). Alternatively, the carrier may be made of metal having a dielectric coating thereon. Such a carrier may realize an insulated metal substrate (IMS).

In some embodiments of the power module according to the invention, the second terminals may be connected with each other so as to from the parallel connection. Alternatively, it is preferred that the second terminal is a kelvin terminal and each die has a fourth terminal, the switching path and the kelvin terminal being between the first terminal and the fourth terminal, the fourth terminals of the dies being connected with each other so as to form the parallel connection. The fourth terminal may be a source terminal, in case of the transistor being a MOSFET or a HEMT, or an emitter terminal, in case of the transistor being an IGBT.

Furthermore, the power module may further comprise a second connector mounted on the substrate and configured to connect the signal source to the power module; and a second electric conductor connecting the second connector to the other terminal of the group, the second electric conductor having a trace section formed on the carrier and an attachment section connecting the trace section with the other terminal of the respective one of the dies, the trace section of the second electric conductor being part of the substrate.

Therein, the second electric conductor may be at least partially made of the (first) electrically conductive material, wherein the trace section and the attachment section of the second electric conductor provide an electric resistance of at least 1 Ω between the second connector and a respective other terminal.

All statements concerning the first connector and the first electric conductor and their connection to the dies may apply analogous to the second connector and the second electric conductor, respectively.

The designated terminal may be the second terminal or the control terminal.

In particular, the following specific designs of the power module according to the invention are preferred:

According to a first design, the second terminals are connected with each other so as to form the parallel connection and the designated terminal is the control terminal. In this case, the resistance is formed between the connector and the control terminal. In this case the second terminal may be a source terminal, in case of the transistor being a MOSFET or a HEMT, or an emitter terminal, in case of the transistor being an IGBT.

According to a second design, the second terminal is a kelvin terminal and each die has a fourth terminal, the switching path and the kelvin terminal being between the first terminal and the fourth terminal, the fourth terminals of the dies being connected with each other so as to form the parallel connection, wherein the designated terminal is the control terminal. In this case, the resistance is formed between the connector and the control terminal. The resistance between the second connector and the second terminal may be lower than 0.5 Ω. In other words, the second electric conductor may be formed conventionally, i.e., with a rather low resistance and/or by the second electrically conductive material.

According to a third design, the second terminal is a kelvin terminal and each die has a fourth terminal, the switching path and the kelvin terminal being between the first terminal and the fourth terminal, the fourth terminals of the dies being connected with each other so as to form the parallel connection, wherein the designated terminal is the second terminal. In this case, the resistance is formed between the connector and the kelvin terminal. The resistance between the second connector and the gate terminal may be lower than 0.5 Ω. In other words, the second electric conductor may be formed conventionally, i.e., with a rather low resistance and/or by the second electrically conductive material.

According to a fourth design, the second terminal is a kelvin terminal and each die has a fourth terminal, the switching path and the kelvin terminal being between the first terminal and the fourth terminal, the fourth terminals of the dies being connected with each other so as to form the parallel connection, the power module further comprising: a second connector mounted on the substrate and configured to connect the signal source to the power module; and a second electric conductor connecting the second connector to the other terminal of the group, the second electric conductor having a trace section formed on the carrier and an attachment section connecting the trace section with the other terminal of the respective one of the dies, the trace section of the second electric conductor being part of the substrate, wherein the second electric conductor is at least partially made of the (first) electrically conductive material, wherein the trace section and the attachment section of the second electric conductor provide an electric resistance of at least 1 Ω between the second connector and a respective other terminal. In this case the a relatively high resistance is formed between the first connector and the control terminal as well as between the second connector and the kelvin terminal. In this case, the designated terminal may be the control terminal.

Furthermore, with regard to the power module according to the invention, the multiple dies, the connector and the electric conductor, and in particular the second connector and the second electric conductor, may form a first arrangement, wherein the power module comprises a corresponding second arrangement, the trace section or the trace sections of the second arrangement being part of the substrate, on which the dies and the connector or the connectors of the second arrangement are mounted. The first and the second arrangement may be connected so as to form a half-bridge. All statements concerning the first arrangement apply to the second arrangement analogously.

The above subject is further solved by an electric power converter, comprising: a DC port for a DC voltage; an AC port with multiple phase conductors for an AC voltage; a power section comprising a plurality of switching elements being interconnected to from a half-bridge for each phase conductor, each half-bridge being connected to the DC port and each phase conductor being connected to a central tap between the switching elements of one of the half-bridges; and a controller configured to provide switching signals so as to convert the DC voltage into the AC by selectively turning on and off the switching elements; wherein each switching element or each half-bridge is formed by a power module according to the invention, wherein the signal source is formed by the controller.

The DC port may have two lines, between which each half-bridge is connected. The power converter may be realized as two-level converter or as three-level-converter.

The electric power converter may be an inverter.

The above subject is further solved by a drive for a mean of transport, for example a vehicle, comprising an electric machine configured to propel the vehicle and an electric power converter according to the invention, the electric machine being connected to the AC port of the electric power converter for supplying the electric machine with the AC voltage.

The above subject is further solved by a mean of transport, comprising an electric drive according to the invention.

### BRIEF DESCRIPTION OF THE DRAWINGS

Further details and advantages of the invention are disclosed in the following, wherein reference is made to the drawings, which show schematically:

FIG. 1 a perspective view of a first embodiment of a power module according to the invention;

FIG. 2 a schematic diagram of the power module according to the first embodiment;

FIG. 3 a perspective view of a second embodiment of a power module according to the invention;

FIG. 4 a schematic diagram of the power module according to the second embodiment;

FIG. 5 a schematic diagram of the power module according to a third embodiment;

FIG. 6 a perspective view of a fourth embodiment of a power module according to the invention;

FIG. 7 a schematic diagram of the power module according to the fourth embodiment;

FIG. 8 a block diagram of an embodiment of an electric power converter according to the invention; and

FIG. 9 a principle drawing of an electric vehicle with an embodiment of an electric drive according to the invention.

### DETAILED DESCRIPTION

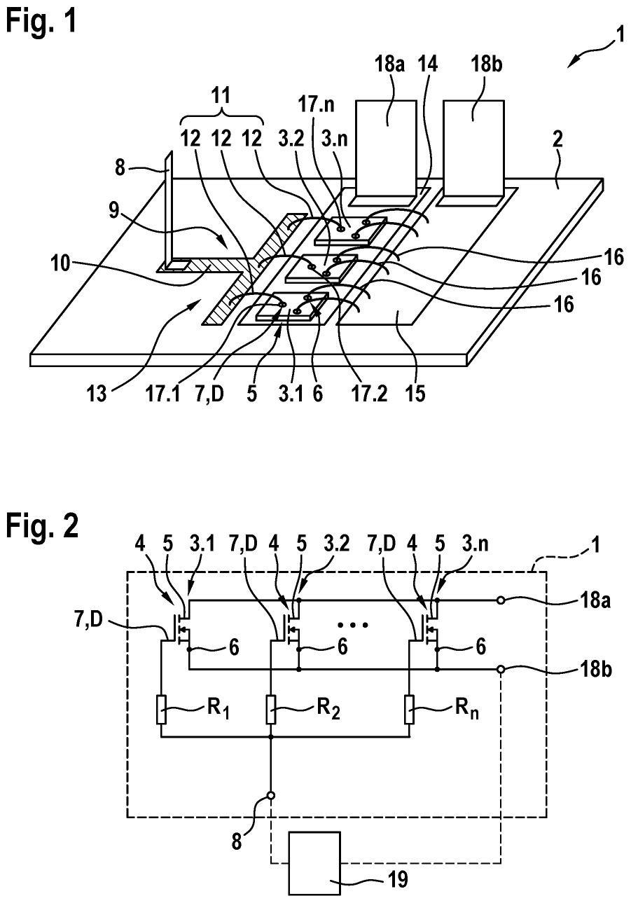

FIG. 1 is a perspective view of a first embodiment of a power module 1.

The power module 1 comprises a carrier 2 and a number n of dies 3, which are individually referred to by the numeral 3.1, 3.2, . . . , 3.n. The dies 3 are connected to a parallel connection. Note that the depicted number of three dies is chosen only for illustrative purposes and that more than three dies, e.g., four, six, eight or even more, may be connected in parallel.

The dies 3 each form a transistor 4 (see FIG. 2) with a switching path. Each die 3 has a first terminal 5, a second terminal 6 and a control terminal 7. The switching path is formed between the first terminal 5 and the second terminal 6. The switching path is switchable depending on a voltage across the control terminal 7 and the second terminal 6. In the present embodiment, each transistor 4 is a SiC-based MOSFET or GaN-based HEMT, the first terminal 5 being a drain terminal, the second terminal 6 being a source terminal and the control terminal 7 being a gate terminal. The first terminals 5 are connected with each other and the second terminals 6 are connected with each other so as to form the parallel connection.

The power module 1 further comprises a connector 8 and an electric conductor 9. The electric conductor connects the connector 8 to a designated terminal D being the control terminal 7. The electric conductor 9 has a trace section 10 which is hatched in FIG. 1 for illustrative purposes and an attachment section 11. The trace section 10 is entirely formed upon the carrier 2 and extends continuously thereon. The attachment section 11 connects the trace section 10 with the designated terminal D of the respective one of the dies 3. In the present embodiment the attachment section 11 is formed by a wire bond 12 for each die 3.

As can be seen further in FIG. 1, the carrier 2 and the trace section 10 are part of a substrate 13, on which the dies and the connector 8 are mounted. The connector 8 is exemplarily mounted on the substrate 13 by being attached on the trace section 10. In particular detail, the substrate 13 further comprises a first pad 14, on which the dies 3 are mounted and which connects the first terminals 5 with each other, and a second pad 15, to which the second terminals 6 are connected by further wire bonds 16 for connecting them with each other.

In particular detail, the attachment section 11 is attached to the trace section 10 and to pads 17.1, 17.2, . . . , 17.n forming the designated terminal D of the respective one of the dies 3.1, 3.2, . . . , 3.n wherein the attachment section 11 extends between the trace section 10 and the pad 17.1, 17.2, . . . , 17.n by forming a clearance to the carrier 2. Thus, the attachment section 11 forms distinct electrical connections between the trace section 10 and each pad 17.1, 17.2, . . . , 17.n.

Optionally, the power module 1 comprises further connectors 18a, 18b being mounted on the substrate 13. The further connector 18a is connected to the first terminals 5 of the dies 3 or to the first pad 14, respectively. The further connector 18b is connected to the second terminals 6 of the dies 3 or the second pad 15, respectively.

FIG. 2 is a schematic diagram of the power module 1 according to the first embodiment.

The connector 8 is configured to connect an external signal source 19 to the power module 1. The further connector 18b is also configured to connect the signal source 19 to the power module so that the voltage across the control terminal 7 and the second terminal 6 for switching the switching path of can be provided to the power module 1.

The trace section 10 and the attachment section 11 are made of a first electrically conductive material and provide an electric resistance with at least 1 Ω, for example at least 10 Ω, between the connector 8 and a respective designated terminal D. I.e., there is an electric resistance R₁ between the connector 8 and the designated terminal D of a first one of the dies 3.1, an electric resistance R₂ between the connector 8 and the designated terminal D of a second one of the dies 3.2 and so on up to an electric resistance Rₙ between the connector 8 and the designated terminal D of an nth one of the dies 3.n and each resistance R₁, R₂, . . . , Rₙ has at least the afore-said value. In particular, a resistance of the electrical connection formed by the attachment section 11 between trace section 10 and the pad 17.1, 17.2, . . . , 17.n of a respective one of dies 3.1, 3.2, . . . , 3.n contributes to the resistance R₁, R₂, . . . , Rₙ between the connector 8 and the respective one of dies 3.1, 3.2, . . . , 3.n.

In the present embodiment, both the trace section 10 and the attachment section 11 are made of the first electrically conductive material, which has a resistivity of at least 4.0·10⁻⁷ Ωm. By the respective geometry, i.e., the diameter and the length, of each of the trace section 10 and the attachment section 11, the resistances R₁, R₂, . . . , Rₙ are achieved. The electrically conductive material may be a copper-manganese-nickel alloy, such as Manganin® or Konstantan®, a nickel-chromium-alloy, such as Nichrome, or an iron-chromium-aluminum alloy, such as Kanthal®.

According to a first modification of the first embodiment, only the trace section 10 is made of the first electrically conductive material and the attachment section 11 is made of a second electrically conductive material and contributes less than 0.5 Ω to the electric resistance R₁, R₂, . . . , Rₙ between the connector 8 and the designated terminal D of a respective one of the dies 3.1, 3.2, . . . , 3.n. The second material may be, e.g., copper or aluminum. Typically, the resistivity of the first electrically conductive material is at least ten times the resistivity of the second electrically conductive material.

According to a second modification of the first embodiment, only the attachment section 11 is made of the first electrically conductive material and the trace section 10 is made of the second electrically conductive material and contributes less than 0.5 QΩ to the electric resistance R₁, R₂, . . . , Rₙ between the connector 8 and the designated terminal D of a respective one of the dies 3.1, 3.2, . . . , 3.n.

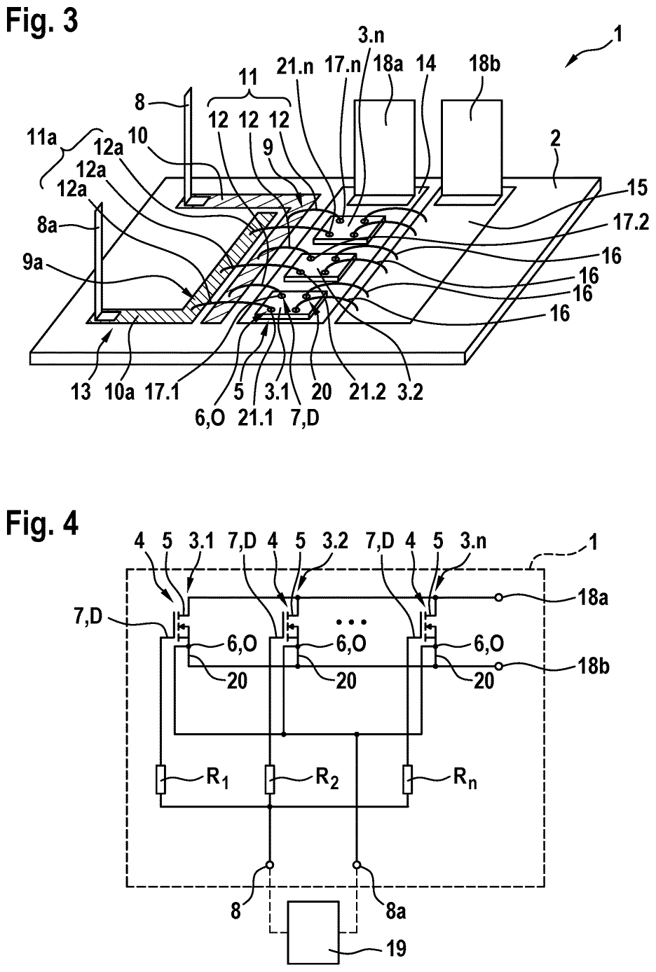

FIG. 3 is a perspective view of a second embodiment of a power module 1.

The power module 1 comprises a carrier 2 and a number n of dies 3, which are individually referred to by the numeral 3.1, 3.2, . . . , 3.n. The dies 3 are connected to a parallel connection. Note that the depicted number of three dies is chosen only for illustrative purposes and that more than three dies, e.g., four, six, eight or even more, may be connected in parallel.

The dies 3 each form a transistor 4 (see FIG. 4) with a switching path. Each die 3 has a first terminal 5, a second terminal 6, a control terminal 7 and a fourth terminal 20. The switching path is formed between the first terminal 5 and the second terminal 6. The switching path is switchable depending on a voltage across the control terminal 7 and the second terminal 6. In the second embodiment, each transistor is a SiC-based MOSFET or a GaN-based HEMT, the first terminal 5 being a drain terminal, the second terminal 6 being a kelvin terminal, the control terminal 7 being a gate terminal and the fourth terminal 20 being a source terminal. The first terminals 5 are connected with each other and the fourth terminals 20 are connected with each other so as to form the parallel connection.

The power module 1 further comprises a first connector 8, a second connector 8a, an electric conductor 9 and a second electric conductor 9a. The first electric conductor 9 connects the first connector 8 to a designated terminal D. The designated terminal is chosen from a group consisting of the control terminal 7 and the second terminal 6. In the present embodiment, the control terminal 7 is chosen as designated terminal D. The other terminal O of the group is, thus, the second terminal 6. The second electric conductor 9a connects the second connector 8a to the other terminal O being the second terminal 6 in the present embodiment. Each electric conductor 9, 9a has a trace section 10, 10a which is hatched in FIG. 3 for illustrative purposes and an attachment section 11, 11a. Each trace section 10, 10a is entirely formed upon the carrier 2 and extends continuously thereon. The attachment section 11 of the first electric conductor 9 connects the trace section 10 of the first electric conductor 9 with the designated terminal D of the respective one of the dies 3. The attachment section 11a of the second electric conductor 9a connects the trace section 10a of the second electric conductor 9a with the other terminal O of the group. In the present embodiment, the attachment section 11, 11a of a respective electric conductor 9, 9a is formed by a wire bond 12, 12a for each die 3.

As can be seen further in FIG. 3, the carrier 2 and the trace section 10, 10a of a respective electric conductor 9, 9a are part of a substrate 13, on which the dies 3 and the connectors 8, 8a are mounted. The first connector 8 is exemplarily mounted on the substrate 13 by being attached on the trace section 10 of the first electric conductor 9. The second connector 8a is exemplarily mounted on the substrate 13 by being attached on the trace section 10a of the second electric conductor 9a. In particular detail, the substrate 13 further comprises a first pad 14, on which the dies 3 are mounted and which connects the first terminals 5 with each other, and a second pad 15, to which the fourth terminals 20 are connected by further wire bonds 16 for connecting them with each other.

In particular detail with regard to the first electric conductor 9, the attachment section 11 is attached to the trace section 10 and to pads 17.1, 17.2, . . . , 17.n forming the designated terminal D of the respective one of the dies 3.1, 3.2, . . . , 3.n. Therein, the attachment section 11 extends between the trace section 10 and the pad 17.1, 17.2, . . . , 17.n by forming a clearance to the carrier 2. Thus, the attachment section 11 forms a distinct electrical connection between the trace section 10 and a respective one of the pads 17.1, 17.2, . . . , 17.n.

Correspondingly with regard to the second electric conductor 9a, the attachment section 11a is attached to the trace section 10a and to pads 21.1, 21.2, . . . , 21.n forming the other terminal O of the group of the respective one of the dies 3.1, 3.2, . . . , 3.n. Therein, the attachment section 11a extends between the trace section 10a and the pad 21.1, 21.2, . . . , 21.n by forming a clearance to the carrier 2. Thus, the attachment section 11a forms a distinct electrical connection between the trace section 10a and a respective one of the pads 21.1, 21.2, . . . , 21.n.

Optionally, the power module 1 comprises further connectors 18a, 18b being mounted on the substrate 13. The further connector 18a is connected to the first terminals 5 of the dies 3 or to the first pad 14, respectively. The further connector 18b is connected to the fourth terminals 20 of the dies 3 or the second pad 15, respectively.

FIG. 4 is a schematic diagram of the power module 1 according to the second embodiment.

The connectors 8, 8a are configured to connect an external signal source 19 to the power module 1 so that the voltage across the control terminal 7 and the second terminal 6 for switching the switching path of can be provided to the power module 1.

With regard to the first electric conductor 9, the trace section 10 and the attachment section 11 are made of a first electrically conductive material and provide an electric resistance with at least 1 Ω, for example at least 10 Ω, between the connector 8 and a respective designated terminal D. I.e., there is an electric resistance R₁ between the first connector 8 and the designated terminal D of a first one of the dies 3.1, an electric resistance R₂ between the first connector 8 and the designated terminal D of a second one of the dies 3.2 and so on up to an electric resistance Rn between the first connector 8 and the designated terminal D of an n^{th} one of the dies 3.n and each resistance R₁, R₂, . . . , Rₙ has at least the aforesaid value. In particular, a resistance of the electrical connection formed by the attachment section 11 between trace section 10 and the pad 17.1, 17.2, . . . , 17.n of a respective one of dies 3.1, 3.2, . . . , 3.n contributes to the resistance R₁, R₂, . . . , Rₙ between the connector 8 and the respective one of dies 3.1, 3.2, . . . , 3.n.

In the present embodiment, both the trace section 10 and the attachment section 11 of the first electric conductor 9 are made of the first electrically conductive material. By the respective geometry, i.e., the diameter and the length, of each of the trace section 10 and the attachment section 11, the resistances R₁, R₂, . . . , Rₙ are achieved. The trace section 10a and the attachment section 11b of the second electric conductor are made of a second electrically conductive material. The attachment sections 11, 11a may be additionally cladded by aluminum. The statements to the first and second electrically conductive materials of the first embodiment apply to the second embodiment as well.

According to a first modification of the second embodiment, only the trace section 10 is made of the first electrically conductive material and the attachment section 11 is made of the second electrically conductive material and contributes less than 0.5 Ω to the electric resistance R₁, R₂, . . . , Rₙ between the connector 8 and the designated terminal D of a respective one of the dies 3.1, 3.2, . . . , 3.n. The other material may be, e.g., copper or aluminum.

According to a second modification of the second embodiment, only the attachment section 11 is made of the first electrically conductive material and the trace section 10 is made of the second electrically conductive material and contributes less than 0.5 Ω to the electric resistance R₁, R₂, . . . , Rₙ between the connector 8 and the designated terminal D of a respective one of the dies 3.1, 3.2, . . . , 3.n.

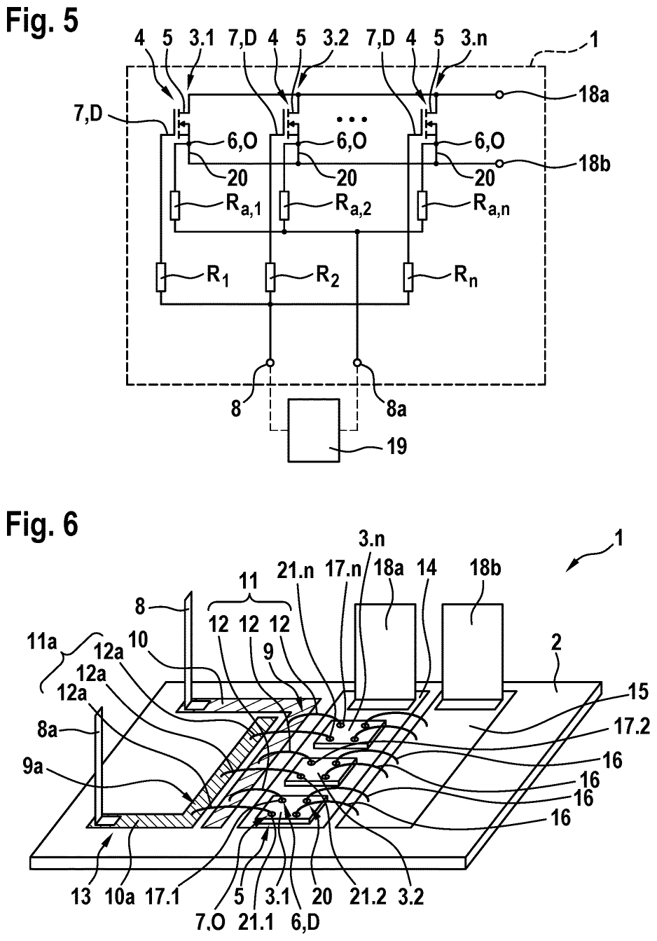

FIG. 5 is a schematic diagram of a power module 1 according to a third embodiment. The third embodiment corresponds to the second embodiment except the differences described in the following. Therein, equal or equivalent members are denoted with identical reference numerals.

In the third embodiment, also the trace section 10a and the attachment section 11a of the second electrical conductor 9a are made of the first electrically conductive material and provide an electric resistance with at least 1 Ω, for example at least 10 Ω, between the second connector 8a and a respective second terminal. I.e., there is an electric resistance R_{a,1} between the second connector 8a and the other terminal O of the first die 3.1, an electric resistance R_{a,2} between the second connector 8a and the other terminal O of the second die 3.2 and so on up to an electric resistance R_{a,n} between the second connector 8a and the other terminal O of an n^{th} dies 3.n and each resistance R_{a,1}, R_{a,2}, . . . , R_{a,n} has at least the aforesaid value. In particular, a resistance of the electrical connection formed by the attachment section 11a between trace section 10a and the pad 21.1, 21.2, . . . , 21.n of a respective one of dies 3.1, 3.2, . . . , 3.n contributes to the resistance R_{a,1}, R_{a,2}, . . . , R_{a,n} between the second connector 8a and the other terminal O of the respective one of dies 3.1, 3.2, . . . , 3.n.

In the present embodiment, both the trace section 10a and the attachment section 11a of the second electric conductor 9a are made of the first electrically conductive material. By the respective geometry, i.e. the diameter and the length, of each of the trace section 10a and the attachment section 11a, the resistances R_{a,1}, R_{a,2}, . . . , R_{a,n} are achieved.

According to a first modification of the third embodiment, only the trace section 10 and/or the trace section 10a are made of the first electrically conductive material and the attachment section 11 and/or the attachment section 11a are made of the second electrically conductive material and contributes less than 0.5 Ω to the electric resistance R₁, R₂, . . . , Rₙ or to the electric resistance R_{a,1}, R_{a,2}, . . . , R_{a,n}, respectively between the connector 8, 8a and the designated terminal D or the other terminal O of a respective one of the dies 3.1, 3.2, . . . , 3.n.

According to a second modification of the third embodiment, only the attachment section 11 and/or the attachment section 11a are made of the first electrically conductive material and the trace section 10 and/or the attachment section 10a are made of the second electrically conductive material and contributes less than 0.5 Ω to the electric resistance R₁, R₂, . . . , Rₙ or to the electric resistance R_{a,1}, R_{a,2}, . . . , R_{a,n}, respectively between the connector 8, 8a and the designated terminal D or to the other terminal O of a respective one of the dies 3.1, 3.2, . . . , 3.n.

FIG. 6 is a perspective view of a fourth embodiment of a power module 1. The fourth embodiment corresponds to the second embodiment except the differences described in the following. Therein, equal or equivalent members are denoted with identical reference numerals.

In the fourth embodiment, the designated terminal D is the second terminal 6, i.e., the kelvin terminal, and the other terminal O of the group is the control terminal. Accordingly, the first electric conductor 9 connects the first connector 8 to second terminal 6 and the second electric conductor 9a connects the second connector 8a to the control terminal 7. In detail, the attachment section 11a of the second electric conductor 9a connects the trace section 10a of the second electric conductor 9a with the control terminal 7. In correspondence with the second embodiment, pads 17.1, 17.2, . . . , 17.n form the designated terminal D and pads 21.1, 21.2, . . . , 21.n form the other terminal O of the respective one of the dies 3.1, 3.2, . . . , 3.n.

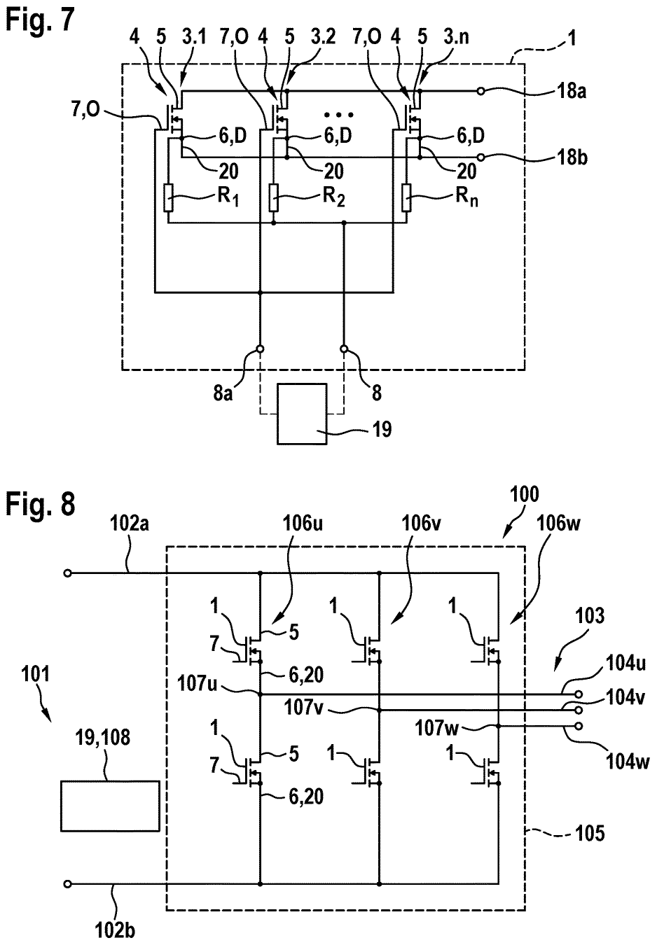

FIG. 7 is a schematic diagram of the power module 1 according to the fourth embodiment.

As can be seen in FIG. 7, the resistances R₁, R₂, R₃ are still between the first connector 8 and the designated terminals D of the dies 3.1, 3.2, . . . , 3.n. However, in the present embodiment, the designated terminals D are the second terminals 6 or kelvin terminals, respectively and the other terminals O of the group are the control terminals 7. Consequently, the trace section 10 and the attachment section 11 of the first conductor 9 connecting the first connector 8 with designated terminal D, i.e., the second terminal 6 or the kelvin terminal, respectively, are made of the first electrically conductive material, whereas the trace section 10a and the attachment section 11a of the second conductor 9a connecting the second connector 8a with the other terminal O of the group, i.e. the control terminal 7, are made of the second electrically conductive material.

The first and second modifications to the second embodiment apply to the fourth embodiment analogously.

With regard to further modifications to the above embodiments the transistor may be an IGBT. In this case, the first terminal 5 is a collector terminal. With regard to the first embodiment the second terminal 6 is an emitter terminal. With regard to the second to fourth embodiments, the fourth terminal is the emitter terminal. The control terminal 7 is a gate terminal of the IGBT.

With regard to further modifications to the above embodiments, the or a respective attachment section 11, 11a is formed by conductive strips instead of wire bonds 12, 12a.

In the above embodiments and their modifications, an LC resonator is formed by the inductance L of electric connections, which connect the dies 3 in parallel, and gate-drain capacitances and gate-source capacitance or gate-collector capacitances and gate-emitter capacitances, respectively. The resistance between the or a respective connector 8, 8a on the one hand and the designated terminal D and/or the kelvin terminal in the embodiments and their modifications, is higher than the corresponding resistance of conventional power modules. The resistances dampen or even suppress oscillations of the LC resonator in the VHF range without the need to redesign the dies 3 or to add additional discrete resistor components to the power module 1.

According to further embodiments, which correspond to the ones above, where the attachment section 11, 11a is made of the first electrically conductive material, only a core of the attachment section 11, 11a is made of the first electrically conductive material and a cladding surrounding the core is made of the second electrically conductive material, e.g. made of aluminum.

According to further embodiments, which correspond to the ones above, where the attachment section 11, 11a is made of the first electrically conductive material, a core of the attachment section 11, 11a is made of an electrically insulting material, e.g. a polymer, and a cladding surrounding the core is made of the first or the second electrically conductive material.

FIG. 8 is a block diagram of an embodiment of an electric power converter 100.

The electric power converter 100 forms an inverter and comprises a DC port 101 with two lines 102a, 102b for a DC voltage, an AC port 103 with multiple phase conductors 104u, 104v, 104w for an AC voltage and a power section 105.

The power section 105 comprises a plurality of switching elements each being formed by a power module 1 according to any of the above embodiments. The switching elements are interconnected to a half-bridges 106u, 106v, 106w for each phase conductor 104u, 104v, 104w. Each half-bridge 106u, 106v, 106w is connected between the lines 102a, 102b and each phase conductor 104u, 104v, 104w is connected to a central tap 107u, 107v, 107w between the switching elements of one of the half-bridges 106u, 106v, 106w.

Further, the electric power converter 100 comprises a controller 108 configured to provide switching signals so as to convert the DC voltage into the AC by selectively turning on and off the switching elements. The controller 108 forms the signal source 19.

Although not shown in FIG. 1 to FIG. 8, according to further embodiments, the power module 1 may comprise a further arrangement of multiple dies 3, a first and/or a second connector 8, 8a and a first and/or a second electric conductor 9, 9a, the trace section or sections 10, 10a of the further arrangement being part of the substrate 13, on which the dies 3 and the connector or connectors 9, 9a of the further arrangement are mounted. Then, the arrangements may be connected so as to form one of the half-bridges 106u, 106v, 106w.

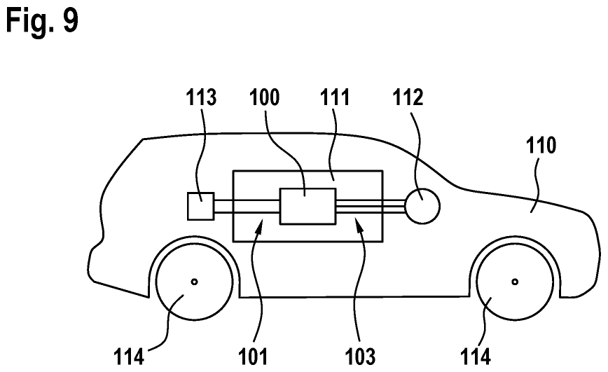

FIG. 9 is a principle drawing of an electric vehicle 110 with an embodiment of an electric drive 111.

The electric drive 111 comprises an electric machine 112 configured to propel the vehicle 110 and an electric power converter 100 according to the above embodiment. The electric machine 112 is connected to the AC port 103 for supplying the electric machine 112. Further, the DC port 101 is connected to a high-voltage battery 113 of the vehicle 110.

The electric vehicle 110 comprises wheels 114 being directly or indirectly, e.g., via a transmission, coupled with the electric drive 111 so as to rotate the wheels 114. According to the embodiment, the electric vehicle 110 is a battery electric vehicle (BEV). Alternatively, the electric vehicle 110 may additionally comprise a combustion engine, therein forming a hybrid vehicle. Further, the electric vehicle 110 may comprise a fuel cell supplying the electric power converter 100.

1. Power module comprising:
a carrier;
multiple dies being connected to a parallel connection and each forming a transistor with a switching path, each die having a first terminal, a second terminal and a control terminal, the switching path being formed between the first terminal and the second terminal and being switchable depending on a voltage across the control terminal and the second terminal, the first terminals of the dies being connected with each other so as to form the parallel connection;
a connector configured to connect a signal source to the power module; and
an electric conductor being made at least partially of an electrically conductive material and connecting the connector to a designated terminal of a respective one of the dies, the designated terminal being chosen from a group consisting of the second terminal and the control terminal, the electric conductor having a trace section formed on the carrier and an attachment section connecting the trace section with the designated terminal of the respective one of the dies;
the carrier and the trace section being part of a substrate, on which the dies and the connector are mounted, wherein
the trace section and the attachment section of the electric conductor provide an electric resistance of at least 1 Ω between the connector and the designated terminal of a respective one of the dies.

2. Power module according to claim 1, wherein
the trace section is formed continuously between the connector and the attachment section.

3. Power module according to claim 1, wherein
the attachment section is attached to the trace section and to pads of the dies forming the designated terminals, wherein the attachment section extends between the trace section and the pad by forming a clearance to the carrier.

4. Power module according to claim 1, wherein
the attachment section is made of the electrically conductive material or comprises a core and an outer cladding surrounding the core, the core or the cladding being made of the electrically conductive material and/or
the trace section is made of the electrically conductive material.

5. Power module according to claim 4, wherein
the core is made of the electrically conductive material and the cladding is made of aluminum or
the core is made of an electrically insulating material, particularly a polymer, and the cladding is made of the electrically conductive material.

6. Power module according to claim 1, wherein the electrically conductive material
has a resistivity of at least 2.0·10⁻⁷ Ωm, preferably at least 3.5·10⁻⁷ Ωm, more preferably at least 4.0·10⁻⁷ Ωm and/or
is a copper-manganese-nickel alloy or a nickel-chromium alloy or an iron-chromium-aluminum alloy.

7. Power module according to claim 1, wherein
the substrate is a direct bonded copper substrate, a direct bonded aluminum substrate, an active metal brazed substrate or an insulated metal substrate.

8. Power module according to claim 1, wherein
the second terminal is a kelvin terminal and each die has a fourth terminal, the switching path and the kelvin terminal being between the first terminal and the fourth terminal, the fourth terminals of the dies being connected with each other so as to form the parallel connection.

9. Power module according to claim 8, further comprising:
a second connector mounted on the substrate and configured to connect the signal source to the power module; and
a second electric conductor connecting the second connector to the other terminal of the group, the second electric conductor having a trace section formed on the carrier and an attachment section connecting the trace section with the other terminal of the respective one of the dies, the trace section of the second electric conductor being part of the substrate.

10. Power module according to claim 9, wherein
the second electric conductor is at least partially made of the electrically conductive material, wherein the trace section and the attachment section of the second electric conductor provide an electric resistance of at least 1 Ω between the second connector and a respective other terminal.

11. Power module according to claim 1, wherein
the designated terminal is the second terminal.

12. Power module according to claim 1, wherein
the second terminals are connected with each other so as to form the parallel connection.

13. Power module according to claim 1, wherein the designated terminal is the control terminal.

14. Electric power converter, comprising
a DC port for a DC voltage;
an AC port with multiple phase conductors for an AC voltage;
a power section comprising a plurality of switching elements being interconnected to from a half-bridge for each phase conductor, each half-bridge being connected to the DC port and each phase conductor being connected to a central tap between the switching elements of one of the half-bridges; and
a controller configured to provide switching signals so as to convert the DC voltage into the AC by selectively turning on and off the switching elements; wherein each switching element or each half-bridge is formed by a power module according to claim 1, wherein the signal source is formed by the controller.

15. Electric drive for a mean of transport, for example a vehicle, comprising an electric machine configured to propel the mean of transport and an electric power converter according to claim 14, the electric machine being connected to the AC port of the electric power converter for supplying the electric machine with the AC voltage.

16. Mean of transport, comprising an electric drive according to claim 15.

17. Power module according to claim 2, wherein
the attachment section is attached to the trace section and to pads of the dies forming the designated terminals, wherein the attachment section extends between the trace section and the pad by forming a clearance to the carrier.

18. Power module according to claim 2, wherein
the attachment section is made of the electrically conductive material or
comprises a core and an outer cladding surrounding the core, the core or the
cladding being made of the electrically conductive material and/or
the trace section is made of the electrically conductive material.

19. Power module according to claim 2, wherein the electrically conductive material
has a resistivity of at least 2.0·10⁻⁷ Ωm, preferably at least 3.5·10⁻⁷ Ωm,
more preferably at least 4.0·10−7 Ωm and/or
is a copper-manganese-nickel alloy or a nickel-chromium alloy or an iron-chromium-aluminum alloy.

20. Power module according to claim 2, wherein
the substrate is a direct bonded copper substrate, a direct bonded aluminum substrate, an active metal brazed substrate or an insulated metal substrate.
